(19) United States
(12) Patent Application Publication
(10) Pub. No.: US 2026/0257244 A1
(43) Pub. Date: Sep. 3, 2026

(54) ULTRASONIC TRANSDUCER SUBSTRATE AND MANUFACTURING METHOD THEREFOR, AND DEVICE

(71) Applicants: Beijing BOE Technology Development Co., Ltd., Beijing (CN); BOE Technology Group Co., Ltd., Beijing (CN)

(72) Inventors: Zhao CUI, Beijing (CN); Tengfei LIU, Beijing (CN); Feng ZHANG, Beijing (CN)

(21) Appl. No.: 18/994,588

(22) PCT Filed: May 14, 2024
(86) PCT No.: PCT/CN2024/093226

§ 371 Date: Jan. 14, 2025

(30) Foreign Application Priority Data
Jun. 13, 2023 (CN) 202310700741.X

(51) Int. Cl. B06B 1/06; B06B 1/02

(52) U.S. Cl. CPC B06B 1/0622; B06B 1/0207

(57) ABSTRACT

Embodiments of the present disclosure disclose an ultrasonic transducer substrate and a manufacturing method therefor, and a device. An ultrasonic transmitting structure can transmit ultrasonic waves, and an ultrasonic receiving structure can receive ultrasonic waves. Compared with an integrated transmitting and receiving structure in the prior art, transmitting and receiving structures provided separately in the present disclosure can be independently controlled. Moreover, in the present disclosure, the ultrasonic receiving structure surrounds the ultrasonic transmitting structure.

### CROSS-REFERENCE TO RELATED APPLICATIONS

The application is a national phase entry under 35 U.S.C § 371 of International Application No. PCT/CN2024/093226, filed on May 14, 2024, which claims the priority of the Chinese patent application No. 202310700741.X, filed with the China National Intellectual Property Administration on Jun. 13, 2023 and named “ULTRASONIC TRANSDUCER SUBSTRATE AND MANUFACTURING METHOD THEREFOR, AND DEVICE”, the entire content of which is incorporated herein by reference.

### TECHNICAL FIELD

The present disclosure relates to the field of ultrasonic detection technology, and in particular to an ultrasonic transducer substrate and a manufacturing method therefor, and a device.

### BACKGROUND

Micromachined Ultrasonic Transducer (MUT) is a type of Micro-Electro-Mechanical System (MEMS) device that makes the piezoelectric film vibrate through the electro effect to emit or receive ultrasonic signals. Herein, micromachined ultrasonic transducers include Piezoelectric Micromachined Ultrasonic Transducer (PMUT) and Capacitance Micromachined Ultrasonic Transducer (CMUT).

These two types of micromachined ultrasonic transducers can bring revolutionary changes to the ultrasonic imaging technology.

### SUMMARY

Embodiments of the present disclosure provide an ultrasonic transducer substrate and a manufacturing method therefor, and a device, and the specific solution is as follows.

Embodiments of the present disclosure provide an ultrasonic transducer device, including a base substrate and a plurality of ultrasonic transducer units disposed on the base substrate; The ultrasonic transducer unit includes: an ultrasonic transmitting structure, configured to convert a received electrical signal into an ultrasonic signal; an ultrasonic receiving structure, where an orthographic projection of the ultrasonic receiving structure on the base substrate surrounds an orthographic projection of the ultrasonic transmitting structure on the base substrate, and the ultrasonic receiving structure is configured to convert a received ultrasonic signal into an electrical signal and output the electrical signal; and a driver circuit disposed between the base substrate and the ultrasonic receiving structure, where the driver circuit is electrically connected to the ultrasonic receiving structure, and the driver circuit is configured to receive the electrical signal from the ultrasonic receiving structure.

In one possible implementation, in the ultrasonic transducer substrate provided by embodiments of the present disclosure, the ultrasonic transmitting structure includes: a cavity close to the base substrate; a first passivation layer, disposed on a side of the cavity facing away from the base substrate, where an orthographic projection of the first passivation layer on the base substrate covers an orthographic projection of the cavity on the base substrate; a first electrode, disposed on a side of the first passivation layer facing away from the base substrate, where the first electrode is configured to receive a driving voltage; a first piezoelectric structure, disposed on a side of the first electrode facing away from the base substrate; and a second electrode, disposed on a side of the first piezoelectric structure facing away from the base substrate, where the second electrode is grounded.

In one possible implementation, in the ultrasonic transducer substrate provided by embodiments of the present disclosure, the ultrasonic transmitting structure further includes an etching hole communicating with the cavity; and the orthographic projection of the first passivation layer on the base substrate does not overlap with an orthographic projection of the etching hole on the base substrate.

In one possible implementation, in the ultrasonic transducer substrate provided by embodiments of the present disclosure, a shape of the orthographic projection of the first passivation layer on the base substrate is the same as a shape of the orthographic projection of the cavity on the base substrate.

In one possible implementation, in the ultrasonic transducer substrate provided by embodiments of the present disclosure, a ratio of a size of the first passivation layer to a size of the cavity is greater than or equal to 1.2 and less than or equal to 1.5.

In one possible implementation, in the ultrasonic transducer substrate provided by embodiments of the present disclosure, the plurality of the ultrasonic transducer units are distributed in an array on the base substrate; and etching holes corresponding to the cavities are provided independently of each other, or, etching holes corresponding to the cavities in the same column communicate with each other.

In one possible implementation, in the ultrasonic transducer substrate provided by embodiments of the present disclosure, a shape of an orthographic projection of the first electrode on the base substrate includes a circle or a square.

In one possible implementation, in the ultrasonic transducer substrate provided by embodiments of the present disclosure, the ultrasonic receiving structure includes: a third electrode spaced apart from the first electrode, where the third electrode and the first electrode are disposed on the same side of the cavity, an orthographic projection of the third electrode on the base substrate surrounds an orthographic projection of the first electrode on the base substrate, and the third electrode is electrically connected to the driver circuit; a second piezoelectric structure, disposed on a side of the third electrode facing away from the base substrate; and a fourth electrode, disposed on a side of the second piezoelectric structure facing away from the base substrate, where the fourth electrode is grounded.

In one possible implementation, in the ultrasonic transducer substrate provided by embodiments of the present disclosure, the first electrode and the third electrode are disposed in the same layer.

In one possible implementation, in the ultrasonic transducer substrate provided by embodiments of the present disclosure, the first electrode and the third electrode are disposed in different layers, and a second passivation layer is disposed between the first electrode and the third electrode.

In one possible implementation, in the ultrasonic transducer substrate provided by embodiments of the present disclosure, the first electrode is closer to the base substrate than the third electrode, or the third electrode is closer to the base substrate than the first electrode.

In one possible implementation, in the ultrasonic transducer substrate provided by embodiments of the present disclosure, the second electrode and the fourth electrode are a one-piece structure disposed across a whole surface, and the first piezoelectric structure and the second piezoelectric structure are a one-piece structure disposed across a whole surface.

In one possible implementation, in the ultrasonic transducer substrate provided by embodiments of the present disclosure, the second electrode and the fourth electrode are spaced apart, and an orthographic projection of the fourth electrode on the base substrate surrounds an orthographic projection of the second electrode on the base substrate; and the first piezoelectric structure and the second piezoelectric structure are spaced apart, and an orthographic projection of the second piezoelectric structure on the base substrate surrounds an orthographic projection of the first piezoelectric structure on the base substrate.

In one possible implementation, the ultrasonic transducer substrate provided by embodiments of the present disclosure further includes a third passivation layer disposed across a whole surface between the first electrode and/or the third electrode, and the first piezoelectric structure; and an organic layer disposed across a whole surface between the first electrode and/or the third electrode, and the first passivation layer.

In one possible implementation, the ultrasonic transducer substrate provided by embodiments of the present disclosure further includes a first lapping electrode disposed in the same layer as the cavity, where the first lapping electrode and the cavity are arranged an intervals. The third electrode is electrically connected to the first lapping electrode, and the first lapping electrode is electrically connected to the driver circuit; and a resin layer is filled around the cavity and around the first lapping electrode.

In one possible implementation, in the ultrasonic transducer substrate provided by embodiments of the present disclosure, a material of the first piezoelectric structure and a material of the second piezoelectric structure include polyvinylidene fluoride.

Correspondingly, embodiments of the present disclosure further provide a device, including the ultrasonic transducer substrate provided by embodiments of the present disclosure.

Correspondingly, embodiments of the present disclosure further provide a method of manufacturing the ultrasonic transducer substrate, for manufacturing the ultrasonic transducer substrate provided by embodiments of the present disclosure. The method includes: providing the base substrate; and forming the plurality of ultrasonic transducer units on a side of the base substrate. The forming the ultrasonic transducer unit includes: forming the driver circuit on a side of the base substrate; and forming the ultrasonic transmitting structure and the ultrasonic receiving structure on a side of the driver circuit facing away from the base substrate. The driver circuit is electrically connected to the ultrasonic receiving structure, and the orthographic projection of the ultrasonic receiving structure on the base substrate surrounds the orthographic projection of the ultrasonic transmitting structure on the base substrate. The ultrasonic transmitting structure is configured to convert the received electrical signal into the ultrasonic signal, the ultrasonic receiving structure is configured to convert the received ultrasonic signal into the electrical signal and output the electrical signal, and the driver circuit is configured to receive the electrical signal from the ultrasonic receiving structure.

In one possible implementation, in the method provided by embodiments of the present disclosure, the ultrasonic transmitting structure includes a cavity, a first passivation layer, a first electrode, a first piezoelectric structure, and a second electrode stacked in sequence. Forming the cavity includes: forming a metal film on a side of the driver circuit facing away from the base substrate; where the metal film includes a cavity region, a non-cavity region and an etching hole region; and the etching hole region communicates with the cavity region; etching the non-cavity region to remove metal in the non-cavity region; filling a resin layer in the non-cavity region in which the metal has been removed; forming the first passivation layer on a side of the cavity region facing away from the base substrate, and etching the first passivation layer, such that an orthographic projection of the first passivation layer on the base substrate covers an orthographic projection of the cavity region on the base substrate, and the orthographic projection of the first passivation layer on the base substrate does not overlap with an orthographic projection of the etching hole region on the base substrate; and injecting an etching solution into the etching hole region to etch the cavity region to remove metal in the cavity region, to form the cavity.

### BRIEF DESCRIPTION OF FIGURES

FIG. 1 shows a schematic diagram of one structure of an ultrasonic transducer substrate provided by embodiments of the present disclosure.

FIG. 2 shows a schematic diagram of yet another structure of the ultrasonic transducer substrate provided by embodiments of the present disclosure.

FIG. 3 shows a schematic diagram of yet another structure of the ultrasonic transducer substrate provided by embodiments of the present disclosure.

FIG. 4 shows a schematic diagram of yet another structure of the ultrasonic transducer substrate provided by embodiments of the present disclosure.

FIG. 5 shows a schematic diagram of yet another structure of the ultrasonic transducer substrate provided by embodiments of the present disclosure.

FIG. 6 shows a schematic diagram of yet another structure of the ultrasonic transducer substrate provided by embodiments of the present disclosure.

FIG. 7 shows a planar schematic diagram of a first electrode and a third electrode.

FIG. 8 shows another planar schematic diagram of a first electrode and a third electrode.

FIG. 9 shows a planar schematic diagram of cavities in a plurality of ultrasonic transducer units.

FIG. 10 shows another planar schematic diagram of cavities in a plurality of ultrasonic transducer units.

FIG. 11 shows a schematic diagram of an ultrasonic imaging principle of an ultrasonic transducer substrate provided by embodiments of the present disclosure.

FIG. 12 shows a first flowchart of a method of manufacturing an ultrasonic transducer substrate provided by embodiments of the present disclosure.

FIG. 13 shows a second flowchart of a method of manufacturing an ultrasonic transducer substrate provided by embodiments of the present disclosure.

FIG. 14A-FIG. 14I shows structural schematic diagrams after each step is executed in manufacturing the ultrasonic transducer substrate provided by embodiments of the present disclosure, respectively.

### DETAILED DESCRIPTION

In order to make the objectives, technical solutions and advantages of embodiments of the present disclosure clearer, technical solutions of embodiments of the present disclosure will be described clearly and completely in the following in conjunction with accompanying drawings of embodiments of the present disclosure. Obviously, the described embodiments are a part of the embodiments of the present disclosure, and not all of the embodiments. And embodiments and features in the embodiments of the present disclosure can be combined with each other without conflict. Based on the described embodiments of the present disclosure, all other embodiments obtained by a person of ordinary skill in the art without the creative labor are within the scope of protection of the present disclosure.

Unless otherwise defined, technical terms or scientific terms used in the present disclosure shall have the ordinary meaning understood by a person of ordinary skill in the art to which the present disclosure belongs. The words “including” or “comprising” and the like used in the present disclosure are intended to mean that the element or object appearing before the word covers the element or object appearing after the word and its equivalents, without excluding other elements or objects. Words such as “connected” or “coupled” are not limited to physical or mechanical connections, but may include electrical connections, whether direct or indirect. The words “inside”, “outside”, “above”, “below”, etc., are used only to indicate relative positional relationships. When the absolute position of the depicted object is changed, the relative positional relationship may also be changed accordingly.

It should be noted that dimensions and shapes of figures in the accompanying drawings do not reflect true proportions and are intended to illustrate the present disclosure only. And throughout the same or similar labeling denotes the same or similar elements or elements having the same or similar function.

Three mainstream micromachined ultrasonic transducer structures in the related art include a PMUT, a CMUT and an ultrasonic imaging device with a sandwich structure.

Herein, the ultrasonic imaging principle of the CMUT is to utilize the difference in capacitance forces between the upper and lower electrodes with a certain interval, enabling the diaphragm located between them to vibrate and emit sound driven by electrostatic attraction. It is necessary to design the interval between the upper and lower electrodes. The interval should not be too large, otherwise the electrostatic attraction will be insufficient. For micromechanical devices, the preparation is rather difficult.

Herein, the ultrasonic imaging principle of the PMUT and sandwich structure is to utilize the direct piezoelectric effect and the inverse piezoelectric effect of the piezoelectric material. When a certain voltage is applied to the piezoelectric material, the piezoelectric material deforms to produce vibration, thus generating ultrasonic waves, and this phenomenon is the inverse piezoelectric effect of the piezoelectric material. When a certain force (ultrasonic wave) is applied to the piezoelectric material, the piezoelectric material deforms and then generates charges on the surface of the material, thereby converting the ultrasonic wave into an electric signal, and this phenomenon is the direct piezoelectric effect of the piezoelectric material. However, for the sandwich structure, the vibration mode of the piezoelectric layer of the sandwich structure is a kind of vibration along a thickness direction (i.e., without setting a cavity), and when it comes to enhancing the intensity of ultrasonic signals, the excitation voltage is generally increased when transmitting ultrasonic signals. Nevertheless, increasing the excitation voltage will, on one hand, lead to an increase in power consumption, and on the other hand, the piezoelectric layer is prone to losing piezoelectric performance due to being punctured.

However, most of the ultrasonic imaging devices in the related technology are designed with the integrated transmitter and receiver, and basically adopt a sandwich structure. This kind of device structure not only has a low signal transmission intensity, but also leads to a weak signal intensity when the signal arrives at the device after reflection. Moreover, it is prone to causing cause crosstalk of the reflected ultrasonic signals between various vibrating elements, increasing noise, reducing the signal-to-noise ratio, and finally affecting the imaging quality.

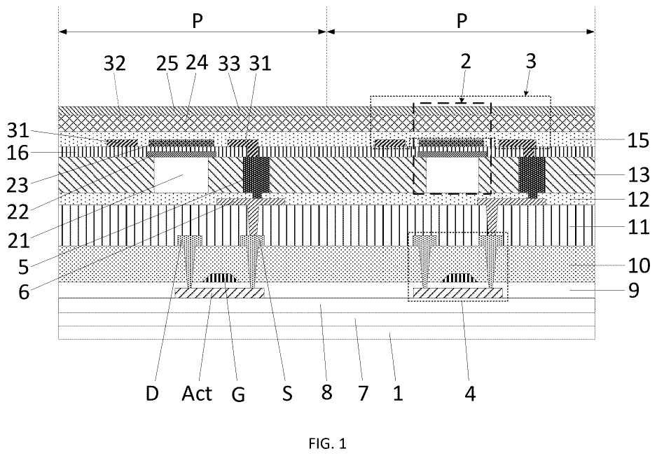

In view of this, embodiments of the present disclosure provide an ultrasonic transducer substrate, as shown in FIG. 1-FIG. 6, including a base substrate 1 and a plurality of ultrasonic transducer units P disposed on the base substrate 1. The ultrasonic transducer unit P includes:
an ultrasonic transmitting structure 2, configured to convert a received electrical signal into an ultrasonic signal;
an ultrasonic receiving structure 3, where an orthographic projection of the ultrasonic receiving structure 3 on the base substrate 1 surrounds an orthographic projection of the ultrasonic transmitting structure 2 on the base substrate 1, and the ultrasonic receiving structure 3 is configured to convert a received ultrasonic signal into an electrical signal and then output it; and
a driver circuit 4, disposed between the base substrate 1 and the ultrasonic receiving structure 3, where the driver circuit 4 is electrically connected to the ultrasonic receiving structure 3, and the driver circuit 4 is configured to receive the electrical signal from the ultrasonic receiving structure 3.

The above-described ultrasonic transducer substrate provided by embodiments of the present disclosure has an ultrasonic transmitting structure that can transmit ultrasonic waves and an ultrasonic receiving structure that can receive ultrasonic waves. Compared to the integrated transmitting and receiving structure in the related art, the separately arranged transmitting and receiving structures in the present disclosure can be independently controlled, so that materials and structures of the ultrasonic transmitting structure and the ultrasonic receiving structure can be designed in a targeted manner, thereby facilitating the improvement of the working performance of the ultrasonic transmitting structure and the ultrasonic receiving structure. Moreover, in the present disclosure, by adopting the ultrasonic receiving structure to surround the ultrasonic transmitting structure, it is possible to avoid the crosstalk of the reflected ultrasonic signals between the ultrasonic receiving structures, reduce the noise of the signals, improve the signal-to-noise ratio, and thus improve the imaging quality and clarity.

Optionally, the base substrate 1 may be a flexible substrate, such as a base substrate of a flexible material such as polyimide, or of course may be a rigid substrate such as glass, quartz or silicon.

Specifically, as shown in FIG. 1-FIG. 6, the driver circuit 4 includes a thin film transistor. The thin film transistor includes: an active layer Act disposed between the base substrate 1 and the ultrasonic receiving structure 3, a gate G disposed between the active layer Act and the ultrasonic receiving structure 3, and a source S and a drain D disposed between the gate G and the ultrasonic receiving structure 3. The ultrasonic transducer substrate further includes: a first lapping electrode 5 disposed between the source S and drain D and the ultrasonic receiving structure 3, and a second lapping electrode 6 disposed between the first lapping electrode 5 and the source S and drain D. One side of the second lapping electrode 6 is electrically connected to the source S or the drain D of the thin film transistor (the present disclosure is based on an example of the second lapping electrode 6 being electrically connected to the source S), the other side of the second lapping electrode 6 is electrically connected to one side of the first lapping electrode 5, and the other side of the first lapping electrode 5 is electrically connected to the ultrasonic receiving structure 3.

Specifically, as shown in FIG. 1-FIG. 6, the ultrasonic transducer substrate further includes: a buffer layer 7 disposed between the base substrate 1 and the active layer Act, a blocking layer 8 disposed between the buffer layer 7 and the active layer Act, a gate insulating layer 9 disposed between the active layer Act and the gate G, an interlayer insulating layer 10 disposed between the gate G and the source S and drain D, a flat layer 11 disposed between the source S and drain D and the second lapping electrode 6, and a fourth passivation layer 12 disposed between the first lapping electrode 5 and the second lapping electrode 6. Herein, the source S and the drain D are electrically connected to the active layer Act through a via-hole penetrating the interlayer insulating layer 10 and the gate insulating layer 9 respectively, the second lapping electrode 6 is electrically connected to the source S through a via-hole penetrating the flat layer 11, and the first lapping electrode 5 is electrically connected to the second lapping electrode 6 through a via-hole penetrating the fourth passivation layer 12.

Optionally, the first lapping electrode 5 and the second lapping electrode 6 may be metal electrodes.

Specifically, as shown in FIG. 1-FIG. 6, only one thin film transistor is depicted for each driver circuit 4 in embodiments of the present disclosure. In the specific device structure, the circuit structure of the driver circuit 4 corresponding to the ultrasonic receiving structure 3 may be a 3T1C structure or a 4T1C structure, and the thin film transistor thereof may be a low temperature poly-silicon (LTPS) structure or a low temperature polycrystalline oxide (LTPO) structure.

In specific implementations, in the above ultrasonic transducer substrate provided in embodiments of the present disclosure, as shown in FIG. 1-FIG. 6, the ultrasonic transmitting structure 2 may include:
a cavity 21, disposed close to the base substrate 1;
a first passivation layer 22, disposed on a side of the cavity 21 facing away from the base substrate 1, an orthographic projection of the first passivation layer 22 on the base substrate 1 covering an orthographic projection of the cavity 21 on the base substrate 1;
a first electrode 23, disposed on a side of the first passivation layer 22 facing away from the base substrate 1, the first electrode 23 being configured to receive a driving voltage;
a first piezoelectric structure 24, disposed on a side of the first electrode 23 facing away from the base substrate 1; and
a second electrode 25, disposed on a side of the first piezoelectric structure 24 facing away from the base substrate 1, the second electrode 25 being grounded.

In specific implementations, in the above ultrasonic transducer substrate provided in the embodiments of the present disclosure, as shown in FIG. 1-FIG. 6, the first lapping electrode 5 may be in the same layer as the cavity 21 with an interval, and a resin layer 13 may be filled around the cavity 21 and the first lapping electrode 5.

In specific implementations, in the above ultrasonic transducer substrate provided by embodiments of the present disclosure, as shown in FIG. 1-FIG. 6, the ultrasonic receiving structure 3 may include:
a third electrode 31 spaced apart from the first electrode 23, where the third electrode 31 and the first electrode 23 are located on the same side of the cavity 21, an orthographic projection of the third electrode 31 on the base substrate 1 surrounds an orthographic projection of the first electrode 23 on the base substrate 1, and the third electrode 31 is electrically connected to the driver circuit 4; specifically, the third electrode 31 is electrically connected to the first lapping electrode 5, i.e., the third electrode 31 is electrically connected to the source S of the thin film transistor in the driver circuit 4 via the first lapping electrode 5 and the second lapping electrode 6;
a second piezoelectric structure 32, disposed on a side of the third electrode 31 facing away from the base substrate 1; and
a fourth electrode 33, disposed on a side of the second piezoelectric structure 32 facing away from the base substrate 1. The fourth electrode 33 is grounded.

Specifically, as shown in FIG. 1-FIG. 6, the ultrasonic transmitting structure 2 is a PMUT structure, and the ultrasonic receiving structure 3 is a sandwich structure. Such device structures not only enhance the emission strength of the ultrasonic signal and improve the imaging quality, but also allow the integrated circuits (ICs) for transmitting and receiving to be separately set and individually controlled.

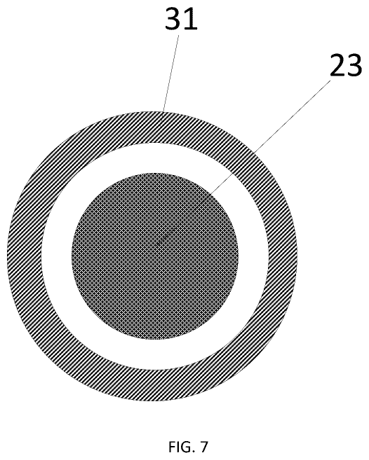

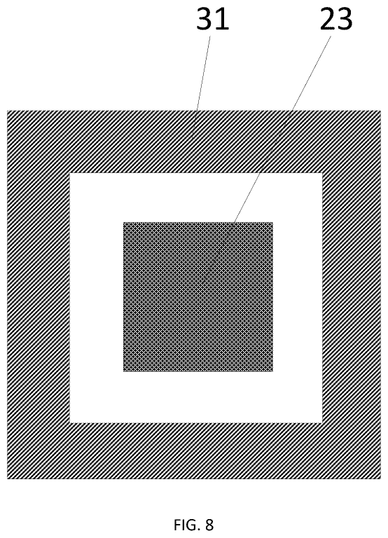

In specific implementations, in the above ultrasonic transducer substrate provided by embodiments of the present disclosure, as shown in FIG. 7, which shows a planar schematic diagram of the first electrode 23 and the third electrode 31, a shape of an orthographic projection of the first electrode 23 on the base substrate 1 is a circle, and an orthographic projection of the third electrode 31 on the base substrate 1 is circular ring-shaped. As shown in FIG. 8, which shows another planar schematic diagram, a shape of the orthographic projection of the first electrode 23 on the base substrate 1 is a square, and the orthographic projection of the third electrode 31 on the base substrate 1 is a square ring-shaped. The concentric ring design of the first electrode 23 and the third electrode 31 can avoid the occurrence of crosstalk phenomenon of the reflected ultrasonic signals between different ultrasonic receiving structures 3, reduce the signal noise, and thereby improve the imaging quality.

Optionally, materials of the above electrodes may be conductive metal materials, such as gold, molybdenum, nickel, etc., which may be formed by using existing technologies such as sputtering, electroplating, etc.

Specifically, as shown in FIG. 1-FIG. 6, the first electrode 23 and the second electrode 25 provide an electrical signal to the first piezoelectric structure 24, the first piezoelectric structure 24 deforms (inverse piezoelectric effect) under the action of the electrical signal, and the cavity 21 provides vibration when the first piezoelectric structure 24 deforms to generate the ultrasonic wave, so that the ultrasonic transmitting structure 2 generates the ultrasonic signal based on the electrical signal and transmits it. The second piezoelectric structure 32 deforms when receiving the ultrasonic signal, and further makes the third electrode 31 have charges (direct piezoelectric effect), thereby generating an electric signal to the driver circuit 4, so that the ultrasonic receiving structure 3 realizes the generation of an electric signal based on the received ultrasonic signal.

Specifically, as shown in FIG. 1-FIG. 6, the ultrasonic transmitting structure 2 of the embodiments of the present disclosure is provided with a cavity 21, so that the vibration mode of the first piezoelectric structure 24 is a cantilever beam vibration mode, which has a larger vibration amplitude, and the generated ultrasonic signals are stronger in strength. Compared with the vibration mode of the sandwich structure along a thickness direction of the piezoelectric layer in the related art, the cantilever beam vibration can enhance the ultrasonic signal strength.

Optionally, materials of the first piezoelectric structure 24 and the second piezoelectric structure 32 may be the same or different. Optionally, the material of the first piezoelectric structure 24 and the material of the second piezoelectric structure 32 may include polyvinylidene fluoride (PVDF). Further, in a case where the material of the first piezoelectric structure 24 and the second piezoelectric structure 32 are the same, both may be organic P(VDF-TrFE) binary copolymers. In a case where the materials of the first piezoelectric structure 24 and the second piezoelectric structure 32 are different, since the ultrasonic transmitting structure 2 needs to emit ultrasonic waves, the first piezoelectric structure 24 thereof may be a material with a strong electro-acoustic conversion capability, such as an organic P(VDF-TrFE-CTE) terpolymer; and since the ultrasonic receiving structure 3 needs to receive ultrasonic waves, the second piezoelectric structure 32 thereof may be a material with a strong acoustic-electric conversion capability, such as an organic P(VDF-TrFE) binary copolymer. Thus, the performance of the ultrasonic transducer substrate can be enhanced.

In specific implementations, in the above-described ultrasonic transducer substrate provided in embodiments of the present disclosure, as shown in FIG. 1-FIG. 6, the ultrasonic transmitting structure 2 further includes an etching hole (not shown) communicating with the cavity 21, and an orthographic projection of the first passivation layer 22 on the base substrate 1 does not overlap with an orthographic projection of the etching hole on the base substrate 1. Specifically, the cavity 21 may be fabricated using an etching method of a metal sacrificial layer. Firstly, the metal of the non-cavity portion is etched away, and then an organic material (such as resin) is used to fill and level it. Subsequently, the first passivation layer 22 is formed, and the first passivation layer 22 is etched to form an opening corresponding to the etching hole. Finally, the metal in the cavity portion is etched away through the etching hole to form the cavity 21.

In the ultrasonic transducer substrate provided in embodiments of the present disclosure, the piezoelectric structure adopts an organic PVDF material, and the cavity is prepared by etching the metal sacrificial layer, to realize the integrated preparation of the ultrasonic transmitting structure, the ultrasonic receiving structure and the thin film transistor.

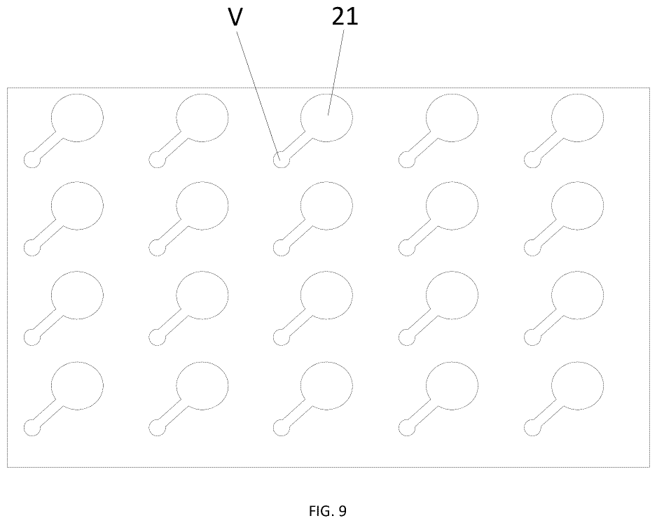

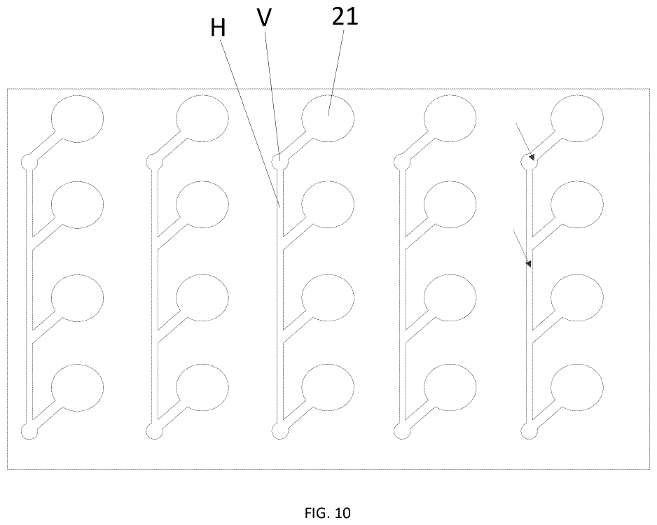

In specific implementations, in the above ultrasonic transducer substrate provided by embodiments of the present disclosure, as shown in FIGS. 9 and 10, which are planar schematic diagrams of cavities 21 in a plurality of ultrasonic transducer units P, the plurality of ultrasonic transducer units P are distributed in an array on the base substrate 1, i.e., a plurality of cavities 21 are distributed in an array on the base substrate 1.

As shown in FIG. 9, etching holes V corresponding to cavities 21 are provided independently of each other, i.e., each cavity 21 is provided with one etching hole V, and the cavities 21 are not associated with each other. Or, as shown in FIG. 10, etching holes V corresponding to the same column of cavities 21 communicate with each other, i.e., it is also possible to provide an etching flow channel H on the same column according to the way of columns to connect etching holes V together in the column.

In specific implementations, in the above ultrasonic transducer substrate provided in embodiments of the present disclosure, as shown in FIG. 1-FIG. 6, a shape of the orthographic projection of the first passivation layer 22 on the base substrate 1 is the same as a shape of the orthographic projection of the cavity 21 on the base substrate 1. Of course, they may also be different.

In specific implementations, in the above ultrasonic transducer substrate provided in embodiments of the present disclosure, the first passivation layer 22 in the ultrasonic emitting structures 2 may be of a one-piece structure, and only the etching holes need to be exposed in the first passivation layer 22 of the one-piece structure.

In specific implementations, in the above ultrasonic transducer substrate provided in embodiments of the present disclosure, as shown in FIG. 1-FIG. 6, the first passivation layer 22 in each ultrasonic emitting structure 2 may be a structure independent of each other, for example, a ratio of a size of the first passivation layer 22 to a size of the cavity 21 is greater than or equal to 1.2 and is less than or equal to 1.5. In this way, the boundary of the first passivation layer 22 can be placed above the resin layer 13 around the cavity 21 to avoid collapse of the piezoelectric structures and electrodes above.

Optionally, the cavity 21 may be a circular cavity, and the first passivation layer 22 may be a circular passivation layer. A ratio of a radius of an orthographic projection of the first passivation layer 22 on the base substrate 1 to a radius of an orthographic projection of the cavity 21 on the base substrate 1 is greater than or equal to 1.2 and less than or equal to 1.5. For example, the size ratio may be 1.2, 1.3, 1.4, or 1.5.

Optionally, the cavity 21 may be a rectangular cavity, and the first passivation layer 22 may be a rectangular passivation layer. A ratio of a diagonal of an orthographic projection of the first passivation layer 22 on the base substrate 1 to a diagonal of an orthographic projection of the cavity 21 on the base substrate 1 is greater than or equal to 1.2 and less than or equal to 1.5. For example, the size ratio may be 1.2, 1.3, 1.4, or 1.5.

In specific implementations, in the above-described ultrasonic transducer substrate provided in embodiments of the present disclosure, the first electrode 23 and the third electrode 31 are disposed in the same layer as shown in FIG. 1. In this way, only by changing the original patterning pattern when forming the first electrode 23, the patterns of the third electrode 31 and the first electrode 23 can be formed through one-time patterning process, without the need to add a separate process for preparing the third electrode 31. This can simplify the preparation process flow, save production costs, and improve production efficiency.

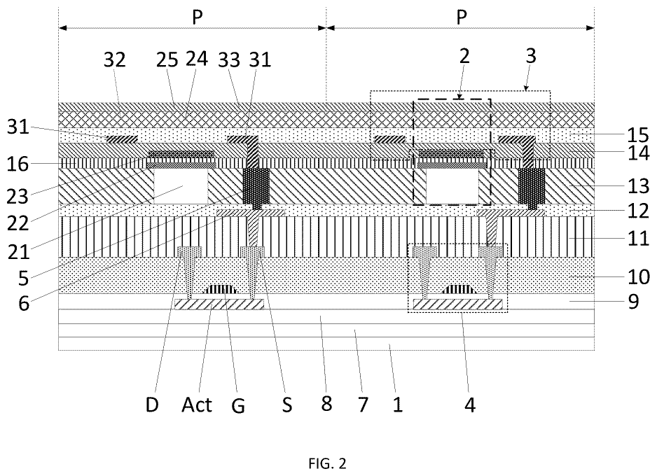

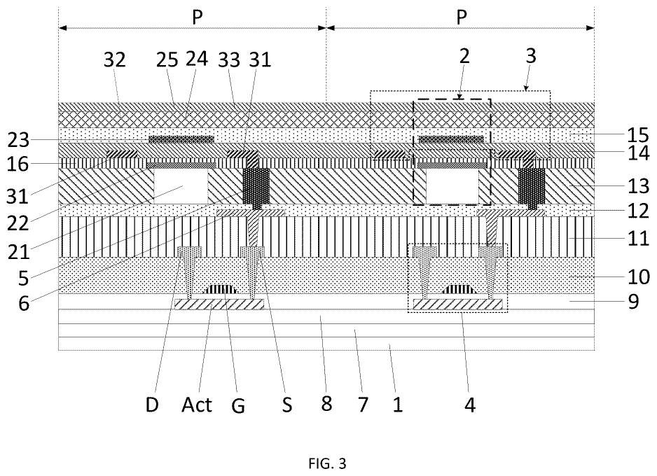

In specific implementations, in the above ultrasonic transducer substrate provided in embodiments of the present disclosure, as shown in FIGS. 2 and 3, the first electrode 23 and the third electrode 31 may be disposed in different layers, and a second passivation layer 14 is disposed between the first electrode 23 and the third electrode 31. In this way, by disposing the first electrode 23 and the third electrode 31 in different layers, it is possible to prevent the generation of coupling capacitance between the first electrode 23 and the third electrode 31 when they are disposed in the same layer, which would lead to an increase in noise, ultimately reduce the signal-to-noise ratio and affect the imaging quality.

Optionally, as shown in FIG. 2, the first electrode 23 is disposed close to the base substrate 1; and as shown in FIG. 3, the third electrode 31 is disposed close to the base substrate 1.

In specific implementations, in the above ultrasonic transducer substrate provided by embodiments of the present disclosure, as shown in FIG. 1-FIG. 3, the second electrode 25 and the fourth electrode 33 may be a one-piece structure disposed as a whole surface, and the first piezoelectric structure 24 and the second piezoelectric structure 32 may be a one-piece structure disposed as a whole surface. In this way, the first electrode 23 and the third electrode 31 share the ground electrode (the second electrode 25 and the fourth electrode 33 of the one-piece structure) disposed as the whole surface, and the ultrasonic transmitting structure 2 and the ultrasonic receiving structure 3 share one piezoelectric layer, which can simplify the fabrication process.

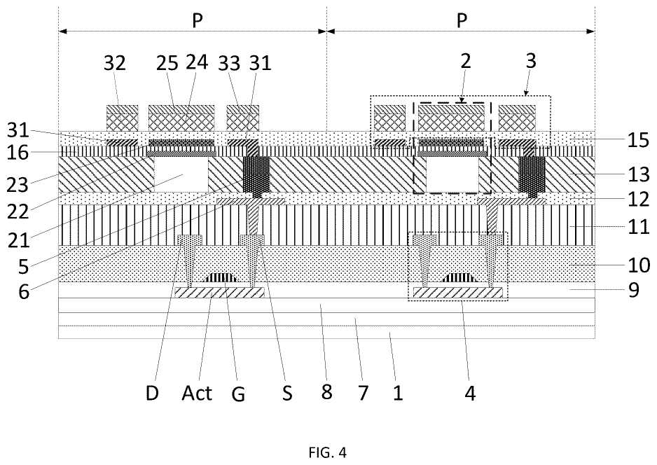

In specific implementations, in the above ultrasonic transducer substrate provided in embodiments of the present disclosure, as shown in FIG. 4-FIG. 6, the second electrode 25 and the fourth electrode 33 may also be spaced apart, and an orthographic projection of the fourth electrode 33 on the base substrate 1 surrounds an orthographic projection of the second electrode 25 on the base substrate 1.

The first piezoelectric structure 24 and the second piezoelectric structure 32 may also be spaced apart, and an orthographic projection of the second piezoelectric structure 32 on the base substrate 1 surrounds an orthographic projection of the first piezoelectric structure 24 on the base substrate 1. In this way, the piezoelectric structures and the ground electrodes of the ultrasonic transmitting structure 2 and the ultrasonic receiving structure 3 are both patterned and correspondingly arranged with the first electrode 23 and the third electrode 31 respectively. This can make the piezoelectric structures of the ultrasonic transmitting structure 2 and the ultrasonic receiving structure 3 not affect each other, thereby making the noise of the signal received by the ultrasonic receiving structure 3 smaller and improving the imaging quality.

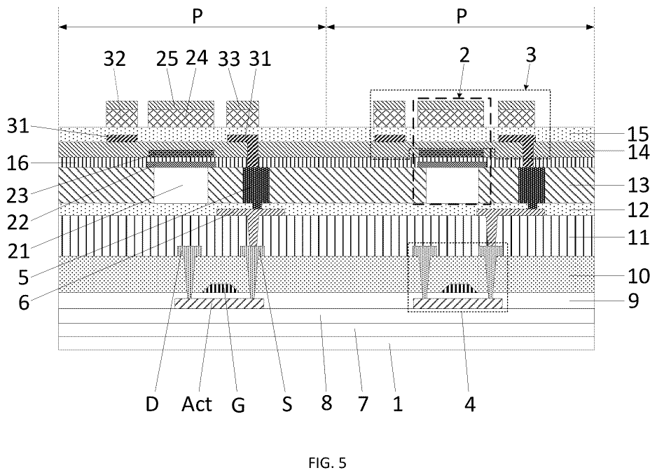

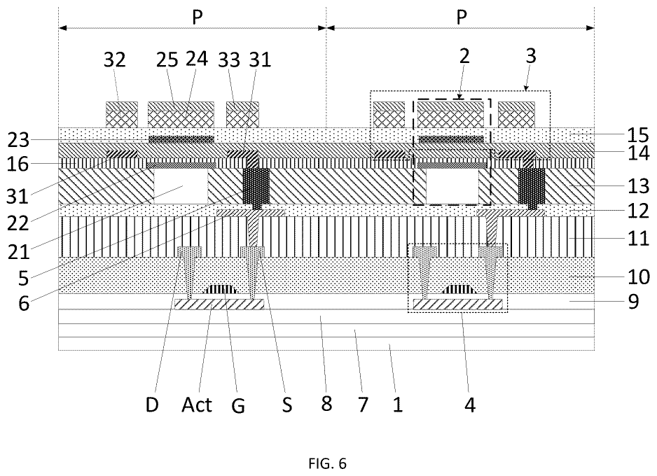

It is to be noted that FIG. 4 shows the second electrode 25 and the fourth electrode 33 spaced apart, and the first piezoelectric structure 24 and the second piezoelectric structure 32 spaced apart based on FIG. 1; FIG. 5 shows the second electrode 25 and the fourth electrode 33 spaced apart, and the first piezoelectric structure 24 and the second piezoelectric structure 32 spaced apart based on FIG. 2; and FIG. 6 shows the second electrode 25 and the fourth electrode 33 spaced apart, and the first piezoelectric structure 24 and the second piezoelectric structure 32 spaced apart based on FIG. 3.

In specific implementations, in the above ultrasonic transducer substrate provided in embodiments of the present disclosure, as shown in FIGS. 1 and 4, the ultrasonic transducer substrate further includes: a third passivation layer 15 provided as a whole surface between the first electrode 23 and the third electrode 31, and the first piezoelectric structure 24; and an organic layer 16 provided as a whole surface between the first electrode 23 and the third electrode 31, and the first passivation layer 22. Specifically, the arrangement of the third passivation layer 15 can protect the first electrode 23 and the third electrode 31 from being eroded during the fabrication of the first piezoelectric structure 24. The material of the organic layer 16 can be Polyimide (PI), so that the first piezoelectric structure 24 can drive the first passivation layer 22 and the organic layer 16 to vibrate together when the first piezoelectric structure 24 vibrates.

In specific implementations, in the above ultrasonic transducer substrate provided in embodiments of the present disclosure, as shown in FIGS. 2 and 5, the ultrasonic transducer substrate further includes: a third passivation layer 15 provided as a whole surface between the third electrode 31 and the first piezoelectric structure 24, and an organic layer 16 provided as a whole surface between the first electrode 23 and the first passivation layer 22. Specifically, the arrangement of the third passivation layer 15 can protect the third electrode 31 from being eroded during the fabrication of the first piezoelectric structure 24. The material of the organic layer 16 can be PI, so that the first piezoelectric structure 24 can drive the first passivation layer 22 and the organic layer 16 to vibrate together when the first piezoelectric structure 24 vibrates.

In specific implementations, in the above ultrasonic transducer substrate provided in embodiments of the present disclosure, as shown in FIGS. 3 and 6, the ultrasonic transducer substrate further includes: a third passivation layer 15 provided as a whole surface between the first electrode 23 and the first piezoelectric structure 24, and an organic layer 16 provided as a whole surface between the third electrode 31 and the first passivation layer 22. Specifically, the arrangement of the third passivation layer 15 can protect the first electrode 23 from being eroded during the fabrication of the first piezoelectric structure 24. The material of the organic layer 16 can be PI, so that the first piezoelectric structure 24 can drive the first passivation layer 22 and the organic layer 16 to vibrate together when the first piezoelectric structure 24 vibrates.

Optionally, materials of the first passivation layer 22, the second passivation layer 14, the third passivation layer 15, and the fourth passivation layer 12 may all be selected from silicon nitride, silicon oxide, silicon oxynitride and the like.

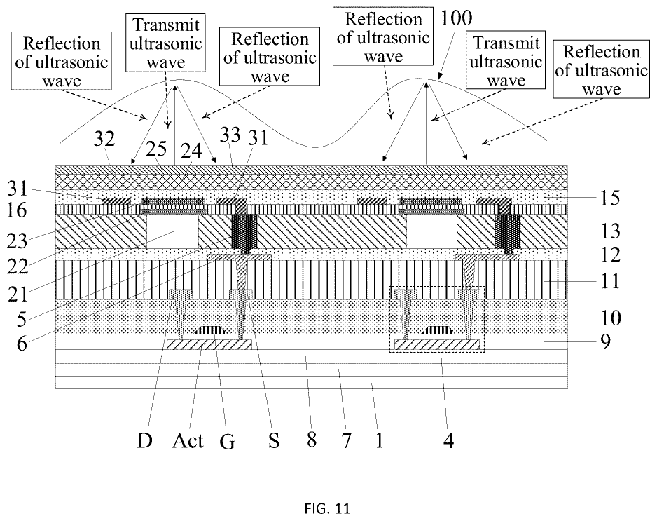

Specifically, as shown in FIG. 11, FIG. 11 illustrates the ultrasonic imaging principle of the ultrasonic transducer substrate provided by the embodiments of present disclosure by taking the structure shown in FIG. 1 as an example. In a transmitting stage, a driving voltage of a certain magnitude is applied to the first electrode 23 to form a potential difference with the second electrode 25, driving the first piezoelectric structure 24 to vibrate to emit an ultrasonic signal. After the ultrasonic signal is reflected by the target object 100 (such as valleys and ridges of a finger), in a receiving stage, the ultrasonic signal returns to the second piezoelectric structure 32 and then the second piezoelectric structure 32 converts a vibration signal into an electrical signal. This electrical signal is detected by the third electrode 31 and the fourth electrode 33 and then transmitted to the driving circuit 4 to form a current to be read. Finally, it is processed by an external integrated circuit (IC) to form an image.

Optionally, the above ultrasonic transducer substrate provided by the embodiments of the present disclosure can be applied to portable electronic devices such as mobile phones for fingerprint detection, and can also be applied to medical ultrasonic detection devices for medical detection, such as B-ultrasound and color Doppler ultrasound detection, etc.

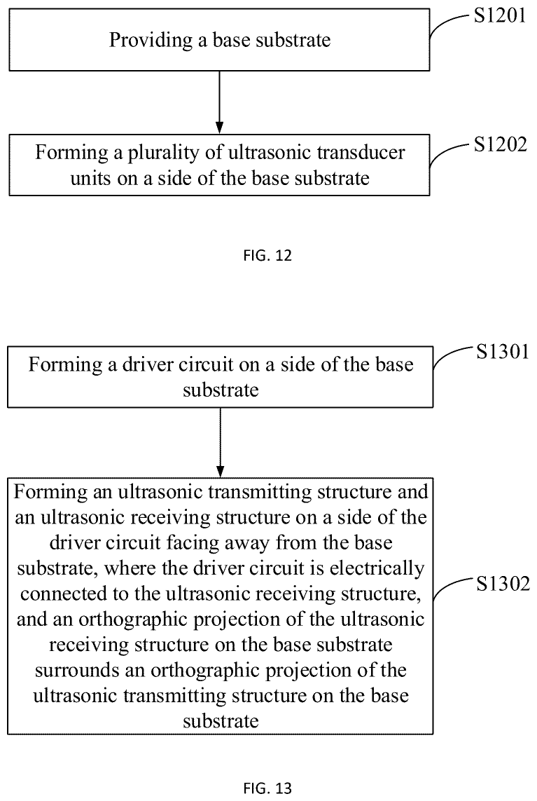

Based on the same inventive concept, embodiments of the present disclosure also provide a method of manufacturing an ultrasonic transducer substrate, for manufacturing the above-described ultrasonic transducer substrate provided by embodiments of the present disclosure. As shown in FIG. 12, the method includes:
S1201, providing a base substrate; and
S1202, forming a plurality of ultrasonic transducer units on a side of the base substrate.

As shown in FIG. 13, forming the plurality of ultrasonic transducer units includes:
S1301, forming a driver circuit on a side of the base substrate; and
S1302, forming an ultrasonic transmitting structure and an ultrasonic receiving structure on a side of the driver circuit facing away from the base substrate, where the driver circuit is electrically connected to the ultrasonic receiving structure, and an orthographic projection of the ultrasonic receiving structure on the base substrate surrounds an orthographic projection of the ultrasonic transmitting structure on the base substrate; where the ultrasonic transmitting structure is configured to convert a received electrical signal into an ultrasonic signal, the ultrasonic receiving structure is configured to convert the received ultrasonic signal into an electrical signal and then outputs the electrical signal, and the driver circuit is configured to receive the electrical signal from the ultrasonic receiving structure.

In the method of manufacturing the above-described ultrasonic transducer substrate provided by embodiments of the present disclosure, by manufacturing the mutually independent ultrasonic transmitting structure and ultrasonic receiving structure, this disclosure can conduct the targeted design for materials and structures of the ultrasonic transmitting structures and the ultrasonic receiving structures compared with the integrated transmitting and receiving structure in the related art, thereby facilitating the improvement of the working performance of the ultrasonic transmitting structures and the ultrasonic receiving structures. Moreover, the ultrasonic receiving structure fabricated in the disclosure surrounds the ultrasonic transmitting structure, which can prevent the reflected ultrasonic signals from causing crosstalk between the ultrasonic receiving structures, reduce signal noise, improve the signal-to-noise ratio, and thereby improve the imaging quality and clarity.

The following takes the structure shown in FIG. 1 as an example to illustrate the method of manufacturing the above ultrasonic transducer substrate provided by embodiments of the present disclosure. Specifically, it includes the following steps.

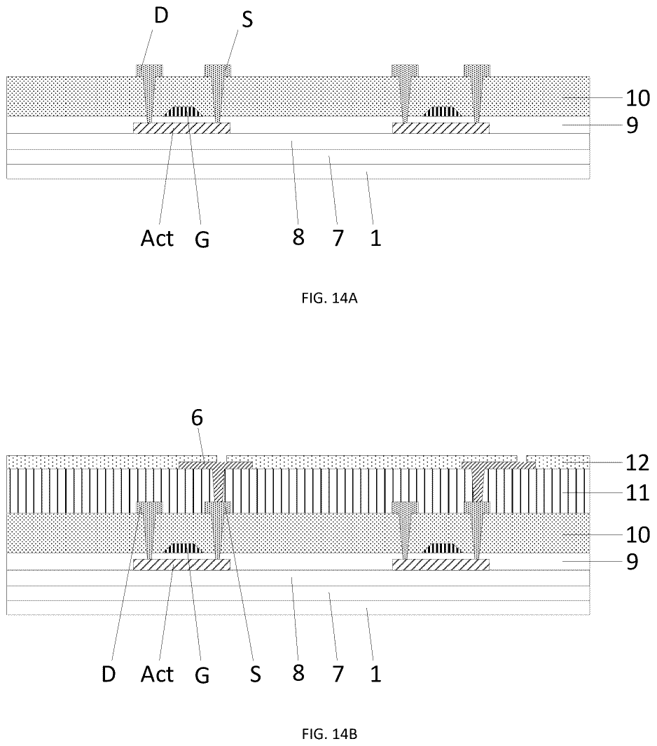

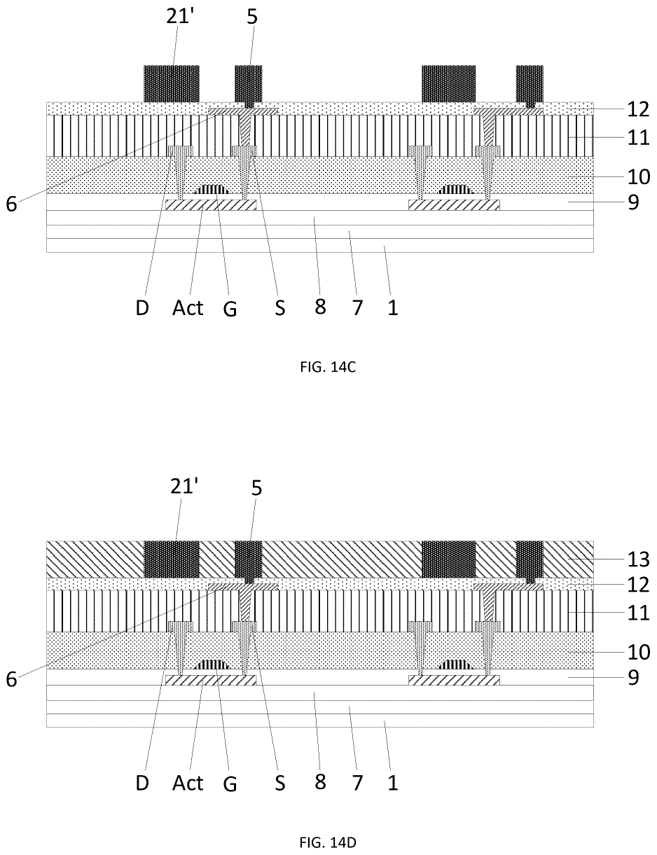

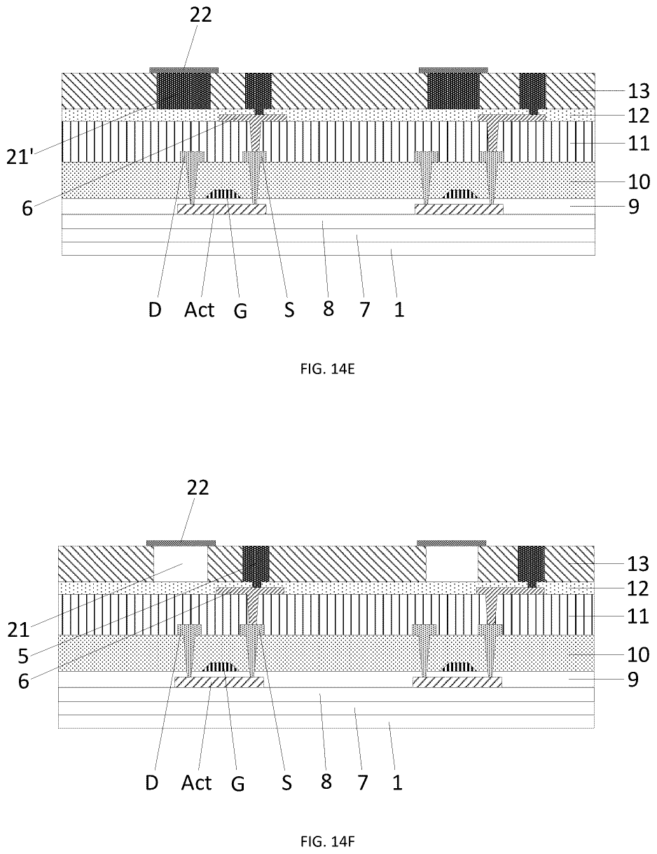

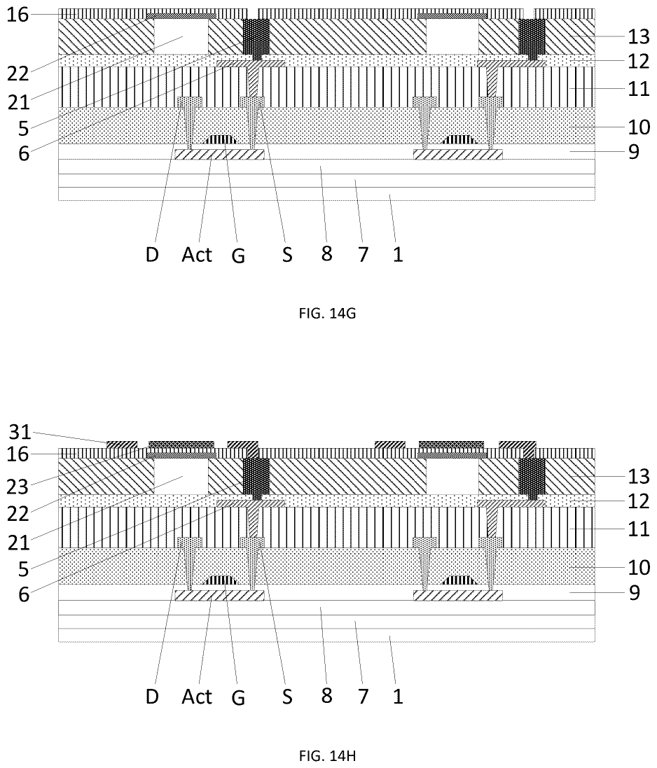

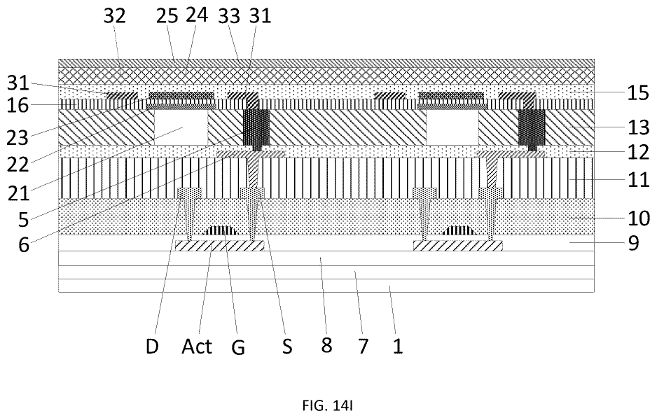

(1) As shown in FIG. 14A, a buffer layer 7 is formed on the base substrate 1, a blocking layer 8 is formed on a side of the buffer layer 7 facing away from the base substrate 1, an active layer Act is formed on a side of the blocking layer 8 facing away from the base substrate 1, a gate insulating layer 9 is formed on a side of the active layer Act facing away from the base substrate 1, the gate insulating layer 9 has via-holes corresponding to the drain D and the source S respectively, a gate G is formed on a side of the gate insulating layer 9 facing away from the base substrate 1, an interlayer insulating layer 10 is formed on a side of the gate G facing away from the base substrate 1, the interlayer insulating layer 10 has via-holes corresponding to the drain D and the source S respectively, and the drain D and the source S are formed on a side of the interlayer insulating layer 10 facing away from the base substrate 1. Herein, the drain D and the source S are electrically connected to the active layer Act through the via-holes in the gate insulating layer 9 and the interlayer insulating layer 10 respectively.

(2) As shown in FIG. 14B, a flat layer 11 is formed on a side of the drain D and the source S facing away from the base substrate 1, the flat layer 11 has a via-hole at the position corresponding to the source S, a second lapping electrode 6 is formed on a side of the flat layer 11 facing away from the base substrate 1, a fourth passivation layer 12 is formed on a side of the second lapping electrode 6 facing away from the base substrate 1, and the fourth passivation layer 12 has a via-hole at the position corresponding to the second lapping electrode 6.

(3) As shown in FIG. 14C, a metal film 21′ is formed on a side of the fourth passivation layer 12 facing away from the base substrate 1; the metal film 21′ includes a cavity region, a non-cavity region, and an etching hole region; the etching hole region is connected to the cavity region; and the non-cavity region is etched to remove metal in the non-cavity region to retain metal in the cavity region and the etching hole region, and metal in the region of the first lapping electrode 5 in the metal film 21′ corresponding to the second lapping electrode 6 is also retained.

(4) As shown in FIG. 14D, the non-cavity region from which the metal has been removed is filled with a resin layer 13.

(5) As shown in FIG. 14E, a first passivation layer 22 is formed on a side of the cavity region facing away from the base substrate 1, and the first passivation layer 22 is etched so that an orthographic projection of the first passivation layer 22 on the base substrate 1 covers an orthographic projection of the cavity region on the base substrate 1, and the orthographic projection of the first passivation layer 22 on the base substrate 1 does not overlap with an orthographic projection of the etching hole region on the base substrate 1.

(6) As shown in FIG. 14F, an etching solution is injected into the etching hole region, and the cavity region is etched to remove metal in the cavity region, to form a cavity 21, and form the first lapping electrode 5 located on the same layer as the cavity 21.

(7) As shown in FIG. 14G, an organic layer 16 is formed on a side of the first passivation layer 22 facing away from the base substrate 1, and the organic layer 16 has a via-hole at a position corresponding to the first lapping electrode 5.

(8) As shown in FIG. 14H, on a side of the organic layer 16 facing away from the base substrate 1, a first electrode 23 and a third electrode 31 which are arranged on the same layer and are concentric rings are formed, and the first electrode 23 corresponds to the cavity 21.

(9) As shown in FIG. 14I, a third passivation layer 15 is formed on a side of the first electrode 23 and the third electrode 31 facing away from the base substrate 1; a first piezoelectric structure 24 and a second piezoelectric structure 32, which are provided as a whole surface and are multiplexed, are formed on a side of the third passivation layer 15 facing away from the base substrate 1; and a second electrode 25 and a fourth electrode, which are provided as a whole surface and are multiplexed, are formed on a side of the first piezoelectric structure 24 facing away from the base substrate 1.

Thus, the ultrasonic transducer substrate shown in FIG. 1 provided by embodiments of the present disclosure is formed by the steps (1)-(9).

It should be noted that the method of manufacturing the ultrasonic transducer substrate shown in FIG. 2-FIG. 6 is basically the same as the method of manufacturing the ultrasonic transducer substrate shown in FIG. 1, with the difference that the first electrode 23 and the third electrode 31 are disposed in different layers, the first piezoelectric structure 24 and the second piezoelectric structure 32 are independent structures, and the second electrode 25 and the fourth electrode 33 are independent structures.

Based on the same inventive concept, embodiments of the present disclosure also provide a device, including the above-described ultrasonic transducer substrate provided by embodiments of the present disclosure.

Optionally, the device may be a display device, i.e., the display device may include the ultrasonic transducer substrate in any of the above embodiments. The ultrasonic transducer substrate may be configured into a fingerprint detection region of the display device, to realize functions such as fingerprint unlocking on the display device. Since ridges and valleys on the finger surface have different reflection intensities of the ultrasonic signal, the ultrasonic energy reflected by the ridges and valleys of the finger is different. By converting this energy difference into an electrical signal difference, the ridges and valleys of the fingerprint can be imaged, and then fingerprint recognition can be carried out.

Optionally, the device may also be a device applied to a medical ultrasonic detection device for medical detection, such as B-ultrasound, color ultrasound detection device, etc.

Since the device solves the problem in a similar principle as the aforementioned ultrasonic transducer substrate, the implementation of the device can be seen in the implementation of the aforementioned ultrasonic transducer substrate, and the repetitions will not be described.

Embodiments of the present disclosure provide an ultrasonic transducer substrate and a manufacturing method therefor, and a device, in which the ultrasonic transmitting structure can transmit ultrasonic waves and the ultrasonic receiving structure can receive ultrasonic waves. Compared to the integrated transmitting and receiving structure in the related art, the separately arranged transmitting and receiving structures in the present disclosure can be independently controlled, so that materials and structures of the ultrasonic transmitting structure and the ultrasonic receiving structure can be designed in a targeted manner, thereby facilitating the improvement of the working performance of the ultrasonic transmitting structure and the ultrasonic receiving structure. Moreover, in the present disclosure, by adopting the ultrasonic receiving structure to surround the ultrasonic transmitting structure, it is possible to avoid the crosstalk of the reflected ultrasonic signals between the ultrasonic receiving structures, reduce the noise of the signals, improve the signal-to-noise ratio, and thus improve the imaging quality and clarity.

Although the preferred embodiments of the present disclosure have been described, those skilled in the art can make additional changes and modifications to these embodiments once they are aware of the basic inventive concepts. Therefore, the appended claims are intended to be construed to include the preferred embodiments as well as all changes and modifications that fall within the scope of the present disclosure.

Apparently, those skilled in the art can make various changes and variations to the embodiments of the present disclosure without departing from the spirit and scope of the embodiments of the present disclosure. In this way, if these modifications and variations of the embodiments of the present disclosure fall within the scope of the claims of the present disclosure and their equivalent technologies, the present disclosure also intends to include these changes and variations.

1. An ultrasonic transducer substrate, comprising a base substrate and a plurality of ultrasonic transducer units disposed on the base substrate;
wherein the ultrasonic transducer unit comprises:
an ultrasonic transmitting structure, configured to convert a received electrical signal into an ultrasonic signal;
an ultrasonic receiving structure, wherein an orthographic projection of the ultrasonic receiving structure on the base substrate surrounds an orthographic projection of the ultrasonic transmitting structure on the base substrate, and the ultrasonic receiving structure is configured to convert a received ultrasonic signal into an electrical signal and output the electrical signal; and
a driver circuit disposed between the base substrate and the ultrasonic receiving structure, wherein the driver circuit is electrically connected to the ultrasonic receiving structure, and the driver circuit is configured to receive the electrical signal from the ultrasonic receiving structure.

2. The ultrasonic transducer substrate according to claim 1, wherein the ultrasonic transmitting structure comprises:
a cavity close to the base substrate;
a first passivation layer, disposed on a side of the cavity facing away from the base substrate, wherein an orthographic projection of the first passivation layer on the base substrate covers an orthographic projection of the cavity on the base substrate;
a first electrode, disposed on a side of the first passivation layer facing away from the base substrate, wherein the first electrode is configured to receive a driving voltage;
a first piezoelectric structure, disposed on a side of the first electrode facing away from the base substrate; and
a second electrode, disposed on a side of the first piezoelectric structure facing away from the base substrate, wherein the second electrode is grounded.

3. The ultrasonic transducer substrate according to claim 2, wherein the ultrasonic transmitting structure further comprises an etching hole communicating with the cavity;
wherein the orthographic projection of the first passivation layer on the base substrate does not overlap with an orthographic projection of the etching hole on the base substrate.

4. The ultrasonic transducer substrate according to claim 3, wherein a shape of the orthographic projection of the first passivation layer on the base substrate is the same as a shape of the orthographic projection of the cavity on the base substrate.

5. The ultrasonic transducer substrate according to claim 4, wherein a ratio of a size of the first passivation layer to a size of the cavity is greater than or equal to 1.2 and less than or equal to 1.5.

6. The ultrasonic transducer substrate according to claim 3, wherein the plurality of the ultrasonic transducer units are distributed in an array on the base substrate; wherein,
etching holes corresponding to the cavities are provided independently of each other, or, etching holes corresponding to the cavities in a same column communicate with each other.

7. The ultrasonic transducer substrate according to claim 2, wherein a shape of an orthographic projection of the first electrode on the base substrate comprises a circle or a square.

8. The ultrasonic transducer substrate according to claim 2, wherein the ultrasonic receiving structure comprises:
a third electrode spaced apart from the first electrode, wherein the third electrode and the first electrode are disposed on a same side of the cavity, an orthographic projection of the third electrode on the base substrate surrounds an orthographic projection of the first electrode on the base substrate, and the third electrode is electrically connected to the driver circuit;
a second piezoelectric structure, disposed on a side of the third electrode facing away from the base substrate; and
a fourth electrode, disposed on a side of the second piezoelectric structure facing away from the base substrate, wherein the fourth electrode is grounded.

9. The ultrasonic transducer substrate according to claim 8, wherein the first electrode and the third electrode are disposed in the same layer.

10. The ultrasonic transducer substrate according to claim 8, wherein the first electrode and the third electrode are disposed in different layers, and a second passivation layer is disposed between the first electrode and the third electrode.

11. The ultrasonic transducer substrate according to claim 10, wherein the first electrode is closer to the base substrate than the third electrode, or the third electrode is closer to the base substrate than the first electrode.

12. The ultrasonic transducer substrate according to claim 9, wherein the second electrode and the fourth electrode are a one-piece structure disposed across a whole surface, and the first piezoelectric structure and the second piezoelectric structure are a one-piece structure disposed across a whole surface.

13. The ultrasonic transducer substrate according to claim 9, wherein the second electrode and the fourth electrode are spaced apart, and an orthographic projection of the fourth electrode on the base substrate surrounds an orthographic projection of the second electrode on the base substrate;
the first piezoelectric structure and the second piezoelectric structure are spaced apart, and an orthographic projection of the second piezoelectric structure on the base substrate surrounds an orthographic projection of the first piezoelectric structure on the base substrate.

14. The ultrasonic transducer substrate according to claim 9, further comprising:
a third passivation layer disposed across a whole surface between the first electrode and the third electrode, and the first piezoelectric structure; and
an organic layer disposed across a whole surface between the first electrode and the third electrode, and the first passivation layer.

15. The ultrasonic transducer substrate according to claim 14, further comprising a first lapping electrode disposed in the same layer as the cavity, wherein the first lapping electrode and the cavity are arranged an intervals;
wherein the third electrode is electrically connected to the first lapping electrode, and the first lapping electrode is electrically connected to the driver circuit;
wherein a resin layer is filled around the cavity and around the first lapping electrode.

16. The ultrasonic transducer substrate according to claim 2, wherein a material of the first piezoelectric structure and a material of the second piezoelectric structure comprise polyvinylidene fluoride.

17. A device, comprising the ultrasonic transducer substrate according to claim 1.

18. A method of manufacturing the ultrasonic transducer substrate according to claim 1, comprising:
providing the base substrate; and
forming the plurality of ultrasonic transducer units on a side of the base substrate;
wherein the forming the ultrasonic transducer unit comprises:
forming the driver circuit on a side of the base substrate; and
forming the ultrasonic transmitting structure and the ultrasonic receiving structure on a side of the driver circuit facing away from the base substrate.

19. The method according to claim 18, wherein the ultrasonic transmitting structure comprises a cavity, a first passivation layer, a first electrode, a first piezoelectric structure, and a second electrode stacked in sequence;
wherein forming the cavity comprises:
forming a metal film on a side of the driver circuit facing away from the base substrate; wherein the metal film comprises a cavity region, a non-cavity region and an etching hole region; and the etching hole region communicates with the cavity region;
etching the non-cavity region to remove metal in the non-cavity region;
filling a resin layer in the non-cavity region in which the metal has been removed;
forming the first passivation layer on a side of the cavity region facing away from the base substrate, and etching the first passivation layer, such that an orthographic projection of the first passivation layer on the base substrate covers an orthographic projection of the cavity region on the base substrate, and the orthographic projection of the first passivation layer on the base substrate does not overlap with an orthographic projection of the etching hole region on the base substrate; and
injecting an etching solution into the etching hole region to etch the cavity region to remove metal in the cavity region, to form the cavity.

20. The ultrasonic transducer substrate according to claim 10, further comprising:
a third passivation layer disposed across a whole surface between the first electrode or the third electrode, and the first piezoelectric structure; and
an organic layer disposed across a whole surface between the first electrode or the third electrode, and the first passivation layer.
